(19) United States
(12) Patent Application Publication
(10) Pub. No.: US 2025/0041731 A1
(43) Pub. Date: Feb. 6, 2025

(54) SYSTEM AND METHOD FOR IMMERSIVE BLENDING OF REAL-LIFE ACTIVITIES WITH GAMING

(71) Applicant: Motivation Studio Inc., Dubai (AE)

(72) Inventors: Magomed Tagibov, Dubai (AE); Ibragim Tagibov, Dubai (AE)

(21) Appl. No.: 18/792,308

(22) Filed: Aug. 1, 2024

Related U.S. Application Data
(60) Provisional application No. 63/530,442, filed on Aug. 2, 2023.

(51) Int. Cl. A63F 13/65; A63F 13/211; A63F 13/212; A63F 13/2145; A63F 13/215; A63F 13/216; A63F 13/285; A63F 13/52; A63F 13/54; A63F 13/67; G06F 3/01

(52) U.S. Cl. CPC A63F 13/65; A63F 13/211; A63F 13/212; A63F 13/2145; A63F 13/215; A63F 13/216; A63F 13/285; A63F 13/52; A63F 13/54; A63F 13/67; G06F 3/017

(57) ABSTRACT

Disclosed are example embodiments of systems and methods for blending real-life activities with gaming to revolutionize gamer interaction with their favorite games. An example system includes a data processing unit configured to receive real-life activity data from a sensor module and game data from a gaming platform. The example system includes an immersive experience module configured to generate immersive virtual environments based on the real-life activities and game data. The example system includes a user interface module configured to present the immersive virtual environments to the user for interaction.

### CROSS-REFERENCE TO RELATED APPLICATION

This patent application claims priority to U.S. Provisional Patent Application No. 63/530,442, filed on Aug. 2, 2023, and entitled “SYSTEM AND METHOD FOR IMMERSIVE BLENDING OF REAL-LIFE ACTIVITIES WITH GAMING.” The disclosure of the prior application is considered part of and is incorporated by reference into this patent application.

### TECHNICAL FIELD

The disclosure relates generally to the field of computer gaming, and specifically and not by way of limitation; some embodiments are related to blending real-life activities with gaming.

### BACKGROUND

Traditional gaming experiences primarily focus on virtual worlds and interactions, often isolating players from real-life activities. This separation can limit engagement and the potential benefits of gaming. There is a growing interest in systems integrating physical activity with virtual gaming environments, offering a more engaging and holistic experience.

Recent advancements in sensor technology, data processing, and immersive environments enable the development of platforms that monitor real-life activities and incorporate them into gaming. Such systems can enhance user enjoyment, promote physical activity, and support healthier lifestyles.

By blending virtual and physical worlds, a system can expand gaming's scope beyond entertainment. Incorporating fitness tracking, educational content, and interactive reading elements can attract a broader user base and open new markets. This multifunctional approach leverages technological advancements to create an engaging and versatile gaming experience.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In one example implementation, an example embodiment includes a system for blending real-life activities with gaming. The example system may bridge the gap between virtual and physical worlds. Accordingly, some examples may offer a transformative gaming experience that integrates real-life activities with gaming. The system may include a data processing unit configured to receive real-life activity data from a sensor module and game data from a gaming platform, an immersive experience module configured to generate immersive virtual environments based on the real-life activities and game data, and a user interface module configured to present the immersive virtual environments to the user for interaction.

One example embodiment includes a system for blending real-life activities with gaming to revolutionize gamer interaction with their favorite games. The example system includes a data processing unit configured to receive real-life activity data from a sensor module and game data from a gaming platform. The example system also includes an immersive experience module configured to generate virtual environments based on the gaming platform's real-life activities and game data. Additionally, the example system includes a user interface module configured to present virtual environments for interaction with the user.

One example embodiment includes a method for blending real-life activities with gaming to revolutionize gamer interaction with their favorite games. The method includes detecting the real-life activities of a user from a sensor module. The method also includes receiving real-life activity data from the sensor module and game data from a gaming platform using a data processing unit. Additionally, the method includes generating virtual environments based on real-life activities and game data using an immersive experience module. The method also includes presenting the virtual environments to the user for interaction using a user interface module.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram that illustrates an example system architecture of a platform in accordance with the systems and methods described herein.

FIG. 2 is a diagram illustrating the system architecture of the digital platform for facilitating resource sharing among organizations in accordance with the systems and methods described herein.

FIG. 3 is a flow diagram illustrating an example method in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or similar reference numbers may be used in the figures to indicate similar or similar functionality.

### DETAILED DESCRIPTION

The detailed description set forth below in connection with the appended drawings is intended as a description of configurations. It is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The systems and methods described herein may be designed to enhance user engagement by seamlessly integrating virtual and physical activities. This integration may be achieved through a combination of advanced sensor technologies, real-time data processing, and immersive virtual environments. The system's architecture may allow for collecting, analyzing, and utilizing real-life activity data to create a dynamic and interactive gaming experience that adapts to the user's physical actions and surroundings.

Some embodiments of the systems and methods described here relate to an immersive experience that revolutionizes how gamers interact with their favorite games by blending real-life activities with gaming. The systems and methods described herein may provide a platform that may seamlessly integrate various aspects of the user's life, such as movie and music streaming, fitness tracking, education, and online reading, with gaming, thereby offering, in some examples, an unparalleled interactive and engaging experience. Some embodiments may utilize real-world metrics to enhance the gaming experience and tap into new markets, catering to a broader range of user interests and preferences.

In one embodiment, the system includes a fitness tracking module that can integrate with popular fitness devices and applications. This module can track various fitness metrics such as steps taken, heart rate, calories burned, and workout duration. By incorporating these metrics into the gaming environment, the system can create challenges and rewards that encourage physical activity. For example, a user might receive in-game rewards for completing a certain number of steps or maintaining a target heart rate during gameplay.

The education module can be configured to provide interactive learning experiences that blend seamlessly with the gaming environment. This module can support a wide range of educational content, from simple quizzes and flashcards to complex simulations and interactive lessons. For instance, a history-themed game could present historical facts and challenge players to answer questions about historical events, while a science game might include virtual experiments and problem-solving exercises.

Another embodiment includes a social networking module that allows users to connect with friends and other players. This module can enable features such as shared gaming experiences, multiplayer challenges, and social leaderboards. Players can form teams, compete in tournaments, and share their achievements on social media platforms. The social networking module can also facilitate voice and video communication during gameplay, enhancing the collaborative experience.

The immersive experience module may include augmented reality (AR) capabilities in addition to virtual reality (VR). AR can overlay digital content onto the real world, allowing users to interact with virtual objects and characters in their physical environment. For example, an AR game might involve users finding and collecting virtual items hidden in their real-world surroundings, or engaging in virtual battles that take place in their living room or backyard.

The system can be designed to support various input devices, including traditional game controllers, motion sensors, touchscreens, and voice commands. This flexibility allows users to interact with the system in a manner that is most comfortable and intuitive for them. For instance, a fitness game might use motion sensors to track a user's movements, while an educational game might use voice commands to answer questions or solve problems.

The data processing unit can utilize machine learning algorithms to continuously improve the gaming experience based on user behavior and preferences. By analyzing data from past gaming sessions, the system can identify patterns and make personalized recommendations for future gameplay. This might include suggesting new games that align with the user's interests, adjusting the difficulty level of challenges, or proposing new fitness goals based on the user's progress.

The communication module can enable seamless integration with other smart devices in the user's home. For example, the system might adjust the lighting and temperature in the room based on the game's environment, or use smart speakers to provide immersive audio experiences. This integration can enhance the overall immersion and make the gaming experience more engaging and enjoyable.

The user interface module can be designed to provide real-time feedback and notifications, keeping users informed about their progress and achievements. This can include on-screen prompts, audio alerts, and haptic feedback. The interface can also display health and fitness metrics, educational progress, and social interactions, giving users a comprehensive overview of their activities and accomplishments within the gaming environment.

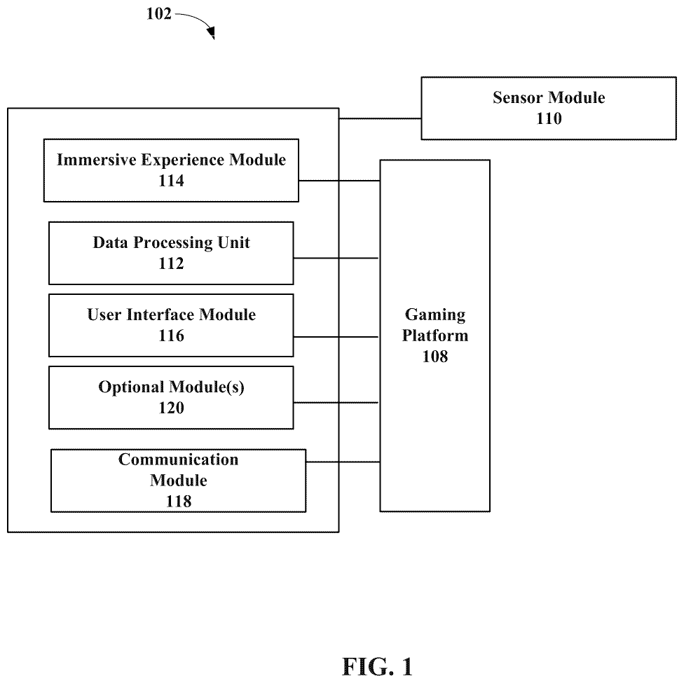

FIG. 1 is a diagram illustrating an example system architecture of a platform in accordance with the systems and methods described herein. System 102 is designed to revolutionize gamer interaction by blending real-life activities with gaming. The system 102 comprises various components, including a gaming platform 108, a sensor module 110, a data processing unit 112, an immersive experience module 114, a user interface module 116, and a communication module 118.

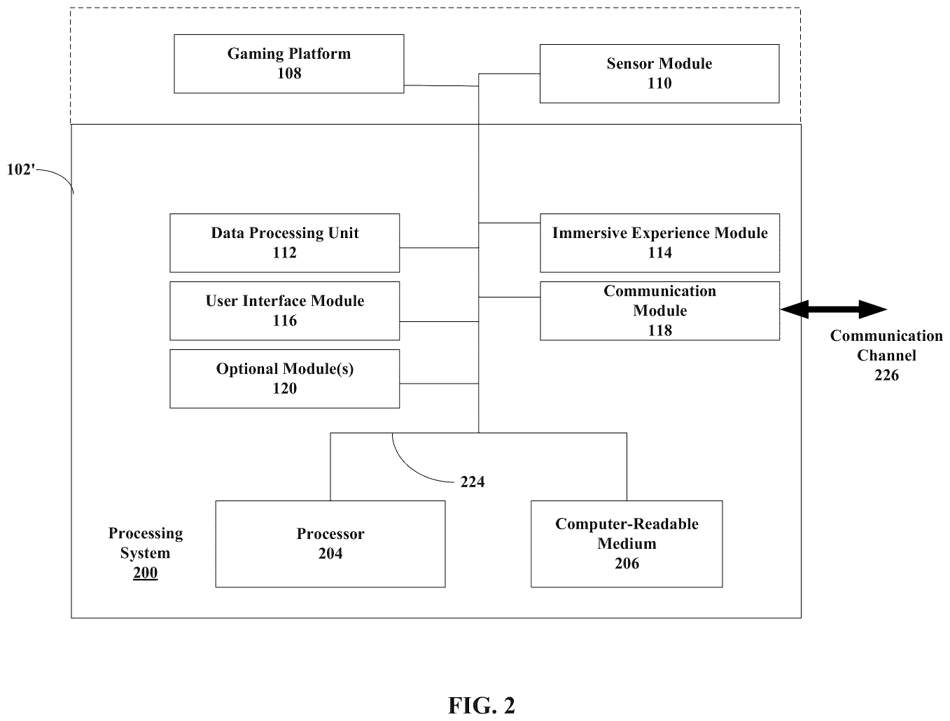

The gaming platform 108 may serve as a central hub, hosting a diverse range of games that offer virtual experiences to users. For example, in the illustrated embodiment of FIG. 1, multiple modules may provide inputs directed by the gaming platform 108 (while in the processor-driven platform of FIG. 2, the gaming platform 108 may be a separate module in communications with the processor) or both. It will be understood that the systems and methods described herein may be implemented in several ways and FIGS. 1 and 2 are two examples.

The gaming platform 108 serves as one example component of the system, hosting various games that can interact with the user's real-life activities. This platform can be designed to support multiple game genres, including action, adventure, role-playing, and simulation games. The platform's architecture may be flexible, allowing for integration of third-party games and applications that can leverage the system's immersive capabilities. The gaming platform may communicate with other system components through wired or wireless connections, ensuring seamless data exchange and synchronization.

The sensor module 110 may be equipped with motion sensors, biometric sensors, and location sensors to detect and interpret the user's real-life activities, such as physical movements and gestures. For example, the sensor module 110 may have multiple sensors to capture various aspects of the user's physical activities. Motion sensors may track the user's movements, such as walking, running, or specific gestures, while biometric sensors can monitor physiological parameters like heart rate, body temperature, and respiratory rate. Location sensors may determine the user's geographical position, enabling location-based gaming experiences. The voice recognition module may also allow users to interact with the system through voice commands, enhancing the hands-free experience.

The data processing unit 112 may act as a central processing hub, receiving real-life activity data from the sensor module and game data from the gaming platform. The data processing unit 112 may combine and analyze the data to generate personalized recommendations and adjust the immersive virtual environments dynamically.

The Data Processing Unit 112 may play a role in analyzing the data received from the sensor module and the gaming platform. The data processing unit 112 may use sophisticated algorithms, including machine learning techniques, to interpret the user's real-life activities and their impact on the gaming environment. The data processing unit may generate personalized recommendations for the user, such as suggesting specific in-game actions based on their physical activity levels or providing feedback on their fitness progress. The integration of predictive analytics may allow the system to anticipate user preferences and dynamically adjust the virtual environments to enhance the overall gaming experience.

The immersive experience module 114 may utilize the processed real-life activity data and game data to generate captivating virtual environments that may seamlessly blend real-life activities with in-game elements.

The immersive experience module 114 may be designed to create virtual environments that are highly responsive to the user's physical activities and in-game actions. This module may generate realistic graphics, spatial audio, and haptic feedback to provide a multi-sensory experience. For instance, if the user performs a running action in the real world, the virtual environment can simulate a running scenario with corresponding visual and auditory effects. The immersive experience module can also incorporate elements from the user's real surroundings, such as integrating real-time weather conditions or geographical features into the game.

The user interface module 116 may present the immersive virtual environments to the user, providing a user-friendly interface for navigation, control, and interaction with the virtual environments.

The user interface module 116 may offer various interaction methods to ensure a seamless and intuitive user experience. This module may support multiple input devices, including touchscreens, gesture recognition systems, and VR headsets. The interface may be designed to be highly customizable, allowing users to configure the layout, controls, and display settings according to their preferences. The user interface module may also provide real-time feedback and notifications, informing users about their in-game progress and real-life activity metrics.

The Communication Module 118 may enable electronic communication between the system and other electronic devices. The communication module 118 may support both wireless communications (such as satellite, microwave, and cellular communication) and wired communications (such as fiber optic communication, telephone lines, ethernet, and USB). The communication module 118 may ensure seamless data exchange and connectivity between the system and external devices.

The communication module 118 may facilitate connectivity between the system and external devices, such as smartphones, tablets, and other gaming consoles. This module may support various communication protocols, including Bluetooth, Wi-Fi, and cellular networks, to ensure reliable and high-speed data transmission. The communication module may enable users to share their gaming experiences on social media platforms, participate in multiplayer games, and access online resources for additional content and support.

The system architecture illustrated in FIG. 1 offers a robust and integrated platform that may seamlessly blend real-life activities with gaming, revolutionizing the gamer's interaction with their favorite games.

In addition to the core components, the system may include various optional features to enhance user engagement and satisfaction. For example, a social networking module may allow users to connect with friends and other gamers, share achievements, and participate in community events. An online marketplace may offer in-game items, accessories, and downloadable content to enrich the gaming experience. Furthermore, the system may support integration with smart home devices, enabling users to control their home environment by adjusting lighting and temperature through in-game actions.

The described system architecture provides an approach to blending real-life activities with gaming. By integrating various modules such as movie and music streaming, fitness tracking, education, and online reading into immersive virtual environments, the system may offer an unparalleled interactive and engaging gaming experience. The combination of real-world metrics, seamless integration of multimedia content, and dynamic adjustment of virtual environments based on user actions and preferences may cater to a diverse audience, revolutionizing how gamers interact with their favorite games.

FIG. 2 provides an example of a hardware implementation for apparatus 102′ employing a processing system 200. The processing system 200 may be implemented with a bus architecture, represented generally by bus 224. Bus 224 may include any number of interconnecting buses and bridges depending on the specific application of the processing system 200 and the overall design constraints. Bus 224 links together various circuits, including one or more processors and/or hardware modules, represented by the processor 204, the modules 108, 110, 112, 114, 116, 118, 120, and the computer-readable medium 206. The bus 224 may also link various other circuits, such as timing sources, peripherals, voltage regulators, and power management circuits, which are well-known in the art and will not be described further.

The processing system 200 includes a processor 204 coupled to a computer-readable medium 206. Processor 204 is responsible for general processing, including executing software stored on computer-readable medium 206. When executed by processor 204, the software causes the processing system 200 to perform the various functions described supra for any particular apparatus. The computer-readable medium 206 may also be used to store data manipulated by processor 204 when executing software. The processing system includes at least one of the modules 108, 110, 112, 114, 116, 118, 120. The modules may be software modules running in processor 204, resident/stored in the computer-readable medium 206, one or more hardware modules coupled to processor 204, or some combination thereof. It will be understood that each of the modules 108, 110, 112, 114, 116, 118, 120 may be implemented within their own processing system, each having its own processor 204 or processors, e.g., multiple parallel processors or other processing circuitry. It will also be understood that the one or more of modules 108, 110, 112, 114, 116, 118, 120 may be grouped together and implemented within multiple processing systems, each having its own processor 204 or processors, e.g., multiple parallel processors, or other processing circuitry.

The apparatus 200/102′ may provide a digital platform accessible by entities via electronic devices. In one example configuration, the apparatus 200/202′ for facilitating resource sharing among entities includes means for storing information related to underutilized resources of said entities in a database (e.g., computer-readable medium 206).

The apparatus 200/102′ for facilitating resource sharing among entities may include a gaming platform 108. The gaming platform 108 may be configured to host various games, e.g., computer games. In other embodiments, apparatus 200/102′ may interact with an external gaming platform 108, e.g., an off-the-shelf gaming platform.

For example, some embodiments may be a platform designed only to reward players in existing games (e.g., on existing gaming platforms 108) for real-world activity. The player neither logs into the game nor downloads the game through the platform. Using the platform, users may check out their progress, look at their achievements, and choose the game on which to spend the accrued bonuses. These bonuses may also be used right within the game interface.

The apparatus 200/102′ for facilitating resource sharing among entities may include a sensor module 110. In an example embodiment, the sensor module may be a motion sensor configured to detect the user's physical movements. In some embodiments, the sensor module may include one or more of the following: a biometric sensor configured to measure the physiological parameters of the user, a location sensor configured to determine the geographical position of the user, and/or a voice recognition module configured to interpret voice commands of the user. In an example embodiment, the sensor module may be configured to detect a user's real-life activities. The sensor module may be further configured to detect the user's emotional state, and the immersive experience module is configured to adapt the immersive virtual environments based on the detected emotional state of the user. In other embodiments, the sensor module 110 may be separate from the apparatus 200/102′.

Some embodiments may not incorporate their own data readers directly into the platform. Instead, the platform may aggregate data from other applications and devices that have already been collected. For example, some embodiments do not include the development of a new fitness band and reading data from that new fitness band but rather collect data from an existing fitness band that is already being worn by the user and aggregates the data already collected by this device and the device's Application.

In some embodiments, players are not encouraged to play the game or games, e.g., to excess, but rather are provided with ways to watch series and courses, listen to music, and do physical exercises (or read their physical form) during the game. Some embodiments collect data about the user's activities throughout the day and reward the user for this in the game. The players do not start watching TV shows or listening to music through the game. They still watch the series, e.g., using a streaming service or other provider outside the game, and then the user may log into the game whenever the user wants and receive bonuses for the series watched. The same goes for other metrics.

The apparatus 200/102′ for facilitating resource sharing among entities may include a data processing unit 112. The data processing unit may be configured to receive real-life activity data from the sensor module and game data from the gaming platform. The data processing unit may include a machine learning module configured to analyze real-life activity data and game data to generate personalized recommendations for the user and/or a predictive analytics module configured to anticipate user preferences and dynamically adjust the immersive virtual environments based on the real-time data.

The apparatus 200/102′ for facilitating resource sharing among entities may include an immersive experience module 114 configured to generate immersive virtual environments based on real-life activities and game data. The immersive experience module may include a virtual reality headset configured to provide a visually immersive experience, a haptic feedback device configured to simulate tactile sensations for the user, and/or an audio output system configured to deliver spatial audio for an enhanced immersive experience. The immersive virtual environments may be dynamically generated based on real-life activities and game data, incorporating elements from the user's surroundings and in-game elements to seamlessly blend real-life and virtual experiences.

The apparatus 200/102′ for facilitating resource sharing among entities may include a user interface module 116 configured to present the immersive virtual environments to the user for interaction. The user interface module may include a gesture recognition module configured to interpret hand and body gestures of the user for interaction with the immersive virtual environments and/or a touch-sensitive display configured to provide a touch-based interface for the user to control and navigate within the immersive virtual environments.

The apparatus 200/102′ for facilitating resource sharing among entities may include a communication module 118. The communication module may allow the processing system 200 to communicate with other processing systems or other electronic devices.

The apparatus 200/102′ for facilitating resource sharing among entities may include one or more optional modules 120, such as one or more of a movie streaming module, a music streaming module, a fitness module, an education module, a social networking module, an online reading module, any other modules described herein, or some combination of these. The movie streaming module may be configured to integrate movie streaming services into immersive virtual environments, enabling users to watch movies while engaging in real-life activities within the games. The music streaming module may be configured to integrate music streaming services into immersive virtual environments, enabling users to listen to music while engaging in real-life activities within the games. The fitness module may be configured to track and analyze the user's real-time fitness metrics during real-life activities and adjust game dynamics based on the fitness metrics to encourage physical fitness and enhance the gaming experience. The education module may be configured to incorporate educational content and learning materials into the immersive virtual environments, allowing users to acquire knowledge and skills while participating in real-life activities within the games. The online reading module may be configured to provide access to digital books, articles, and other written content within the immersive virtual environments, enabling users to read and engage with written material while engaging in real-life activities within the games.

The movie streaming module may further include a content recommendation engine configured to suggest movies based on the user's gaming preferences and real-life activities and/or a synchronized playback module configured to allow the user to, in some examples, seamlessly transition between movie watching and real-life activities within the games.

The social networking module may be configured to connect users with similar gaming and movie preferences, enabling multiplayer interactions and shared movie experiences within immersive virtual environments. In some embodiments, one or more of the gaming platform 108 and the sensor module 110 may communicate with the processor 204 through the communication module 118 over the communication channel 226 rather than directly using the bus 224, as illustrated in FIG. 2.

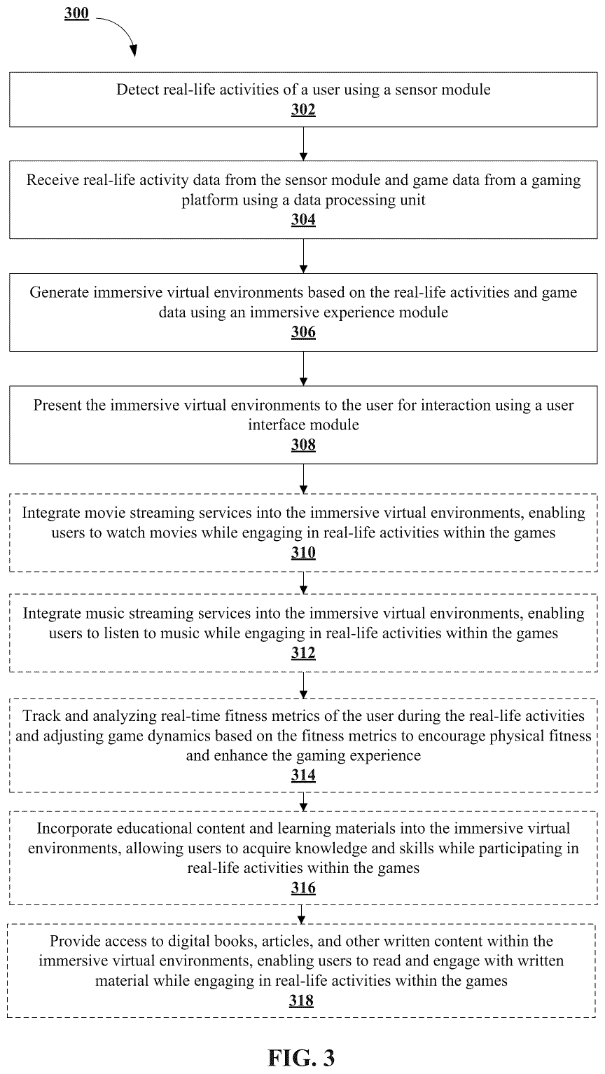

FIG. 3 is a flow diagram illustrating an example method 300 in accordance with the systems and methods described herein. In some example embodiments, method 300 may blend real-life activities with gaming to revolutionize gamer interaction with their favorite games. Method 300 may include detecting real-life activities of a user from a sensor module (302), receiving real-life activity data from the sensor module and game data from a gaming platform using a data processing unit (304), generating immersive virtual environments based on the real-life activities and game data using an immersive experience module (306), and presenting the immersive virtual environments to the user for interaction using a user interface module (308).

In some example, embodiments, the example method 300 may include integrating movie streaming services into the immersive virtual environments, enabling users to watch movies while engaging in real-life activities within the games (310). In some example, embodiments, the example method 300 may include integrating music streaming services into immersive virtual environments, enabling users to listen to music while engaging in real-life activities within the games (312). In some example embodiments, the example method 300 may include tracking and analyzing real-time fitness metrics of the user during real-life activities and adjusting game dynamics based on the fitness metrics to encourage physical fitness and enhance the gaming experience (314). In some example embodiments, method 300 may include incorporating educational content and learning materials into the immersive virtual environments, allowing users to acquire knowledge and skills while participating in real-life activities within the games (316). In some example embodiments, the example method 300 may provide access to digital books, articles, and other written content within the immersive virtual environments, enabling users to read and engage with written material while engaging in real-life activities within the games (318).

Detecting real-life activities of a user from a sensor module (302) may include one or more of the following activating the sensor module integrated within the system, capturing a user's physical movements, gestures, and other relevant data using motion sensors, biometric sensors, location sensors, and voice recognition modules, and/or continuously monitoring and analyzing the real-life activity data from the sensor module.

Receiving real-life activity data from the sensor module and game data from a gaming platform, e.g., using a data processing unit (304), may include one or more of the following establishing communication channels between the sensor module, data processing unit and gaming platform, receiving real-life activity data from the sensor module, which includes the captured physical movements, gestures, and other relevant data, receiving game data from the gaming platform, including information about the user's progress, achievements, and in-game events, and/or combining the real-life activity data and game data within the data processing unit.

Generating immersive virtual environments based on real-life activities and game data using an immersive experience module (306) may include one or more of the following: analyzing the combined real-life activity data and game data within the data processing unit, utilizing machine learning algorithms and predictive analytics to interpret the user's actions, preferences, and in-game context, generating immersive virtual environments that may seamlessly blend elements from the user's real-life activities and in-game elements, and/or dynamically adjusting the virtual environments based on the real-time data, providing an interactive and captivating gaming experience.

Presenting the immersive virtual environments to the user for interaction using a user interface module (308) may include one or more of the following utilizing the user interface module to present the generated immersive virtual environments to the user providing a user-friendly interface that allows users to navigate, control, and interact with the virtual environments, enabling interaction through gestures, touch-based inputs, or other suitable methods based on the capabilities of the user interface module, and/or continuously update and synchronize the immersive virtual environments with the user's real-life activities and game progress, ensuring a seamless and immersive user experience.

Integrating movie streaming services into the immersive virtual environments, enabling users to watch movies while engaging in real-life activities within the games (310) may include one or more of integrating movie streaming services into the immersive virtual environments of the system, establishing a seamless connection between the movie streaming module and the immersive experience module, provide users with a library of movies to choose from, either through a built-in collection or by accessing popular movie streaming platforms, enabling users to select and play movies while remaining within the immersive virtual environments, and/or synchronizing the movie playback with the user's real-life activities and game progress, ensuring a cohesive and uninterrupted experience.

Integrating music streaming services into the immersive virtual environments, enabling users to listen to music while engaging in real-life activities within the games (312) may include one or more of integrating music streaming services into the immersive virtual environments of the system, establishing a seamless connection between the music streaming module and the immersive experience module, providing users with access to a vast library of songs and music genres, enabling users to select and play music tracks while participating in real-life activities within the games, and/or may integrate the music seamlessly with the gaming experience, allowing users to enjoy personalized soundtracks that enhance their immersion.

Tracking and analyzing real-time fitness metrics of the user during real-life activities and adjusting game dynamics based on the fitness metrics to encourage physical fitness and enhance the gaming experience (314) may include one or more of integrating a fitness module into the system to track and analyze real-time fitness metrics, utilizing sensors and biometric data to monitor the user's physical activity, such as steps taken, heart rate, calories burned, and other relevant parameters, continuously analyze the fitness metrics within the data processing unit, and/or adjusting the game dynamics based on the real-time fitness metrics, encouraging physical fitness and creating a connection between real-life activities and the gaming experience.

Incorporating educational content and learning materials into the immersive virtual environments, allowing users to acquire knowledge and skills while participating in real-life activities within the games (316) may include one or more of integrating an education module into the system to incorporate educational content and learning materials, provide a range of educational content, including interactive lessons, quizzes, and challenges, within the immersive virtual environments, aligning the educational content with the user's interests, preferences, and the game's theme, and/or enabling users to engage with the educational content while participating in real-life activities within the games, fostering knowledge acquisition and skill development.

Providing access to digital books, articles, and other written content within the immersive virtual environments, enabling users to read and engage with written material while engaging in real-life activities within the games (318) may include one or more of integrating an online reading module into the system to provide access to digital books, articles, and written content, offering a wide range of digital reading materials within the immersive virtual environments, allowing users to browse, select, and read books, articles, and other written content without leaving the gaming platform, and/or ensuring a seamless reading experience that complements the user's real-life activities and gaming interactions.

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, block, feature, or function or embodied in several components, steps, or functions. Additional elements, components, steps, and/or functions may be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Some portions of the detailed description are presented regarding algorithms and symbolic representations of operations on data bits within a computer memory. Those skilled in the data processing arts use these algorithmic descriptions and representations to most effectively convey the substance of their work to others skilled in the art. An algorithm is generally conceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless expressly stated otherwise as apparent from the following disclosure, it is appreciated that throughout the disclosure, terms such as “processing,” “computing,” “calculating,” “determining,” “displaying,” or the like refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are unrelated to any particular computer or apparatus. Various general-purpose systems may be used with programs in accordance with the teachings herein, or it may prove convenient to construct more specialized apparatus to perform the required method steps. The required structure for various systems will appear from the description below. It would be appreciated if a variety of programming languages were used to implement the invention's teachings as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or similar reference numbers may be used in the figures to indicate similar or similar functionality.

The foregoing description of the embodiments of the present invention has been presented for illustration and description purposes. It is not intended to be exhaustive or to limit the present invention to the precise form disclosed. Many modifications and variations are possible in light of the above teaching. It is intended that the scope of the present invention be limited not by this detailed description but rather by the claims of this Application. As will be understood by those familiar with the art, the present invention may be embodied in other specific forms without departing from the spirit or essential characteristics thereof. Likewise, the particular naming and division of the modules, routines, features, attributes, methodologies, and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies, and other aspects of the present invention can be implemented as software, hardware, firmware, or any combination of the three. Also, wherever a component, an example of which is a module, of the present invention is implemented as software, the component can be implemented as a standalone program, as part of a more extensive program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims to present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later become known to those of ordinary skill in the art are expressly incorporated herein by reference and are intended to be encompassed by the claims.

Moreover, nothing disclosed herein is intended to be dedicated to the public, regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for blending real-life activities with gaming, comprising:
a data processing unit configured to receive real-life activity data from a sensor module and game data from a gaming platform;
an immersive experience module configured to generate virtual environments based on the real-life activities and game data from the gaming platform; and
a user interface module configured to present the virtual environments to the user for interaction.

2. The system of claim 1, further comprising a movie streaming module configured to integrate movie streaming services into the virtual environments, enabling users to watch movies while engaging in real-life activities within the games.

3. The system of claim 1, further comprising a music streaming module configured to integrate music streaming services into the virtual environments, enabling users to listen to music while engaging in real-life activities within the games.

4. The system of claim 1, further comprising a fitness module configured to track and analyze real-time fitness metrics of the user during the real-life activities and adjust game dynamics based on the fitness metrics.

5. The system of claim 1, further comprising an education module configured to incorporate educational content and learning materials into the virtual environments, allowing users to acquire knowledge and skills while participating in real-life activities within the games.

6. The system of claim 1, further comprising an online reading module configured to provide access to digital books, articles, and other written content within the virtual environments, enabling users to read and engage with written material while engaging in real-life activities within the games.

7. The system of claim 1, wherein the sensor module further comprises:
a motion sensor configured to detect physical movements of the user;
a biometric sensor configured to measure physiological parameters of the user;
a location sensor configured to determine the geographical position of the user;
a voice recognition module configured to interpret voice commands of the user.

8. The system of claim 1, wherein the data processing unit further comprises:
a machine learning module configured to analyze real-life activity data and game data to generate personalized recommendations for the user;
a predictive analytics module configured to anticipate user preferences and dynamically adjust the virtual environments based on the real-time data.

9. The system of claim 1, wherein the experience module further comprises:
a virtual reality headset configured to provide a visually experience to the user;
a haptic feedback device configured to simulate tactile sensations for the user;
an audio output system configured to deliver spatial audio.

10. The system of claim 1, wherein the user interface module further comprises:
a gesture recognition module configured to interpret hand and body gestures of the user for interaction with the virtual environments;
a touch-sensitive display configured to provide a touch-based interface for the user to control and navigate within the virtual environments.

11. The system of claim 1, wherein the movie streaming module further comprises:
a content recommendation engine configured to suggest movies based on the user's gaming preferences and real-life activities;
a synchronized playback module configured to allow the user to transition between movie watching and real-life activities within the games.

12. The system of claim 1, further comprising:
a social networking module configured to connect users with similar gaming and movie preferences, enabling multiplayer interactions and shared movie experiences within the virtual environments.

13. The system of claim 1, wherein the virtual environments are dynamically generated based on the real-life activities and game data, incorporating elements from the user's surroundings and in-game elements for a seamless blending of real-life and virtual experiences.

14. The system of claim 1, wherein the sensor module is further configured to detect the user's emotional state, and the experience module is configured to adapt the virtual environments based on the detected emotional state of the user.

15. A method for blending real-life activities with gaming to revolutionize gamer interaction with their favorite games, comprising:
detecting real-life activities of a user from a sensor module;
receiving real-life activity data from the sensor module and game data from a gaming platform using a data processing unit;
generating virtual environments based on the real-life activities and game data using an immersive experience module; and
presenting the virtual environments to the user for interaction using a user interface module.

16. The method of claim 15, further comprising integrating movie streaming services into the virtual environments, enabling users to watch movies while engaging in real-life activities within the games.

17. The method of claim 15, further comprising integrating music streaming services into the virtual environments, enabling users to listen to music while engaging in real-life activities within the games.

18. The method of claim 15, further comprising tracking and analyzing real-time fitness metrics of the user during the real-life activities and adjusting game dynamics based on the fitness metrics to encourage physical fitness and enhance the gaming experience.

19. The method of claim 15, further comprising incorporating educational content and learning materials into the virtual environments, allowing users to acquire knowledge and skills while participating in real-life activities within the games.

20. The method of claim 15, further comprising providing access to digital books, articles, and other written content within the virtual environments, enabling users to read and engage with written material while engaging in real-life activities within the games.
